(19) United States
(12) Patent Application Publication
(10) Pub. No.: US 2017/0037981 A1
(43) Pub. Date: Feb. 9, 2017

(54) SELF-SHUT VALVE FOR FAUCET

(71) Applicant: Hsiang-Shih Wang, Changhua (TW)

(72) Inventor: Hsiang-Shih Wang, Changhua (TW)

(73) Assignee: GEANN INDUSTRIAL CO.,LTD., CHANGHUA (TW)

(21) Appl. No.: 14/817,425

(22) Filed: Aug. 4, 2015

(51) Int. Cl. F16K 21/04; E03C 1/04

(52) U.S. Cl. CPC F16K 21/04; E03C 1/04; E03C 2001/026

(57) ABSTRACT

A self-shut valve for a faucet may include a valve body, a valve base, a control shaft and a top cap. The control shaft includes a sealing portion that comprises a ducting pipe and a slot which can prevent the space between the valve base and the control shaft from entering into a vacuum state to enable the control shaft to return to its initial position precisely.

### FIELD OF THE INVENTION

The present invention relates to a faucet, more particularly to a faucet with a self-shut valve that can automatically shut off after a given period of time.

### BACKGROUND OF THE INVENTION

Currently, there are various kinds of faucet assembly and equipment, and the manual faucet is a kind of faucet that is usually used in public restrooms. However, a great amount of water resources could be wasted since the user cannot shut off the faucet completely after usage. Therefore, in order to overcome this problem, it is necessary to provide a faucet with a self-shut valve.

Generally, a conventional self-shut faucet comprises a control valve formed inside thereof to control the flow of water. The valve can be opened by pressing the top cap of the faucet and closed automatically after a given period of time due to a spring inside the valve pushing the valve to return to its initial position. It is more sanitary to use a self-shut faucet because the user does not have to touch the faucet after washing hands, and it also saves water when the faucet can be turn off automatically.

However, conventional self-shut faucet is disadvantageous because the control valve of the conventional self-shut faucet has no ducting holes inside to prevent the control valve from entering a vacuum state. As a result, when the water pressure in the control valve is larger than the elastic force of the spring, the control valve will enter a vacuum state, resulting in the spring failing to return the control valve to its initial position. In a worse scenario, the valve cannot even be shut. Therefore, there remains a need for a new and improved design for a self-shut faucet to overcome the problems presented above.

### SUMMARY OF THE INVENTION

The present invention provides a self-shut faucet, which comprises a valve body, a valve base, a control shaft and a top cap. The valve body is hollow and has a compartment formed inside thereof. A water inlet is formed at a bottom portion of the compartment, and an opening is formed at a top portion thereof to connect the valve base, and a plurality of water outlets are formed at a lateral portion of the compartment between the water inlet and the opening. The valve base comprises a slot axially penetrating through a central portion thereof in order to receive the control shaft, and a chamber formed inside the valve base is connected to a lower end of the slot. A plurality of outlet holes is formed at a lower periphery of the slot. A diameter of the chamber is larger than the slot, and a blocking piece is formed at a top portion of the chamber. A plurality of inlet holes is formed on an outer wall of the chamber, and an outer threaded segment is formed at a lower end of the sealing gasket to be screwed by a bottom nut. An annual groove is formed at an upper surface of the protruding portion in order to receive a coil spring. The control shaft comprises a body portion, a sealing portion and a connecting end. The body portion is secured inside the slot of the valve base, and the connecting end formed at an upper end of the control shaft in order to connect the top cap. The sealing portion formed at a lower end of the body portion is secured inside the chamber, and an O-ring is disposed thereon to prevent water leak. Also a diameter of the sealing portion is larger than the body portion. A recessed portion is formed at a lower portion of the sealing portion in order to receive the buffer spring. A T-shaped ducting pipe is extended from a top of the recessed portion, and a branch thereof is extended from a lateral wall of the ducting pipe to connect a slot of the sealing portion. A central shaft is formed inside the buffer spring, and an upper end thereof is inserted into a lower end of the ducting pipe.

Comparing with conventional self-shut valves for faucets, the present invention is advantageous because: (i) the sealing portion of the control shaft comprises the ducting pipe and the slot which can prevent the space between the valve base and the control shaft from entering a vacuum state. Thus, the control shaft can return to its initial position precisely; and (ii) the central shaft formed inside the buffer spring is moved corresponding to the control shaft inside the ducting pipe. The movement of the central shaft can achieve the clean effect of the ducting pipe, and enforce the air conduction inside the faucet valve. As a result, the control shaft pressed by the coil spring can be returned to its initial position precisely.

### BRIEF DESCRIPTION OF THE DRAWINGS

FIG. 1 is a three-dimensional view of the self-shut valve for a faucet in the present invention.

FIG. 2 is an exploded view of the self-shut valve for a faucet in the present invention.

FIG. 3 is an exploded view of the valve base and the control shaft of the self-shut valve for a faucet in the present invention.

FIG. 4 is a sectional, schematic view of the self-shut valve for a faucet in the present invention when the faucet is closed.

FIG. 5 is a sectional, schematic view of the self-shut valve for a faucet in the present invention when the faucet is opened.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

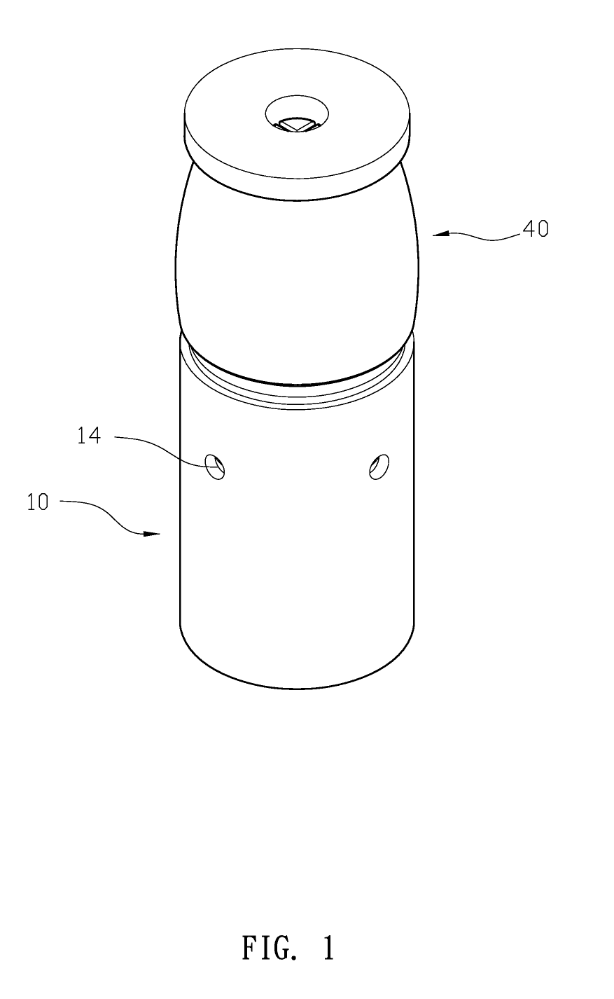

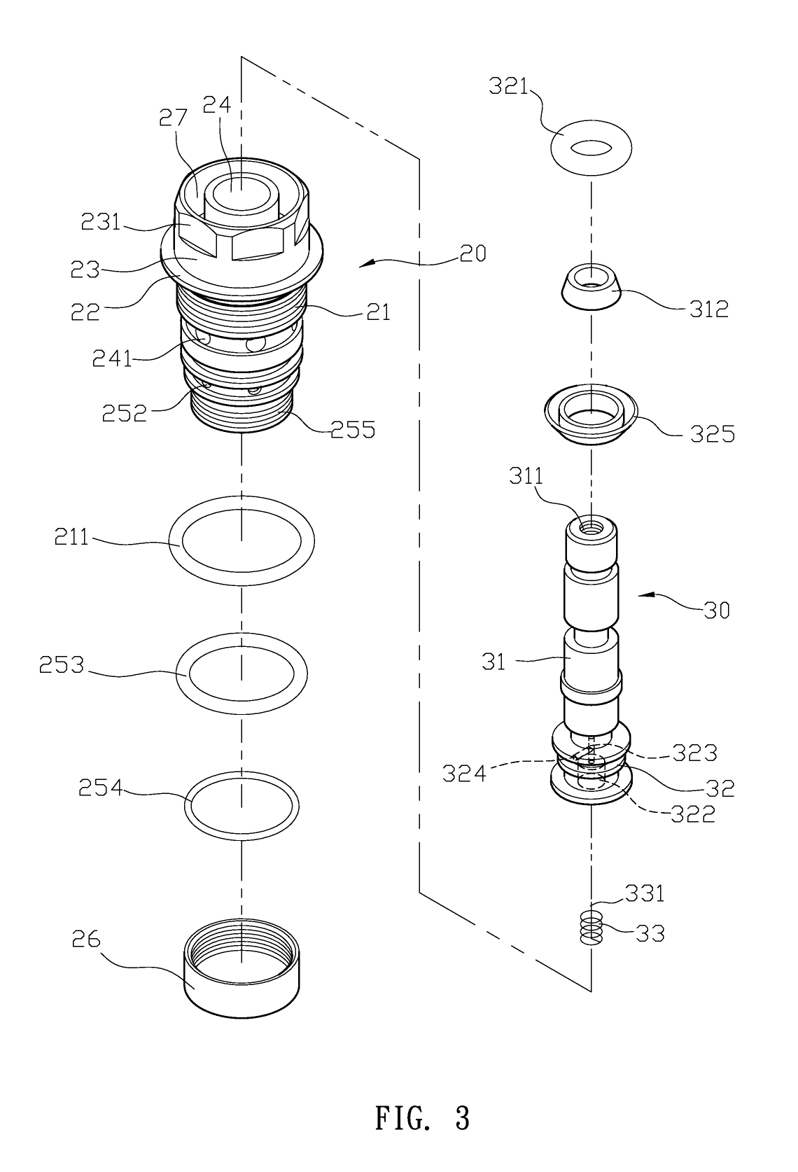

Referring to FIGS. 1 to 4, the present invention provides a self-shut valve for a faucet, which comprises a valve body (10), a valve base (20), a control shaft (30) and a top cap (40). The valve body (10) is hollow and has a compartment (11) formed inside thereof. A water inlet (12) is formed at a bottom portion of the compartment (11), and an opening (13) is formed at a top portion thereof to connect with the valve base (20). A plurality of water outlets (14) are formed at a lateral portion of the compartment (11) between the water inlet (12) and the opening (13). A second threaded segment (21) on a center portion of the valve base (20) is connected to a first threaded segment (111) on an upper portion of the valve body (10) to secure the valve body (10) on the valve base (20). A flange (22) formed on a top of the second segment (21) of the valve base (20) is pressed against a peripheral edge of the opening (13), and a watertight gasket (211) is disposed on the valve body (20), and a position thereof is between the flange (22) and the second threaded segment (21). A protruding portion (23) is formed at a top portion of the flange (22), and an engaging portion (231) is formed at a top periphery thereof to lose its circular shape. The valve base (20) comprises a slot (24) axially penetrating through a central portion thereof in order to receive the control shaft (30), and a chamber (25) formed inside the valve base (20) is connected to a lower end of the slot (24). A plurality of outlet holes (241) is formed at a lower periphery of the slot (24). A diameter of the chamber (25) is larger than the slot (24), and a blocking piece (251) is formed at a top portion of the chamber (25). A plurality of inlet holes (252) is formed at an outer wall of the chamber (25), and a leakproof gasket (253) disposed beyond the inlet holes (252) is pressed against the inner wall of the valve body (10) to achieve the sealing effect. A sealing gasket (254) disposed on an outer wall of the chamber (25) is located below inlet holes (252), and an outer threaded segment (255) is formed at a lower end of the sealing gasket (254) to be screwed by a bottom nut (26). An annual groove (27) is formed at an upper surface of the protruding portion (23) in order to receive a coil spring (28). The control shaft (30) comprises a body portion (31), a sealing portion (32) and a connecting end (311). The body portion (31) is secured inside the slot (24) of the valve base (20), and the connecting end (311) is formed at an upper end of the control shaft (30) in order to connect the top cap (40). The sealing portion (32) formed at a lower end of the body portion (31) is secured inside the chamber (25), and an O-ring (321) is disposed thereon to prevent water leak. Also, a diameter of the sealing portion (32) is larger than the body portion (31). A recessed portion (322) is formed at a lower portion of the sealing portion (32) in order to receive the buffer spring (33). A T-shaped ducting pipe (323) is extended from a top portion of the recessed portion (322), and a branch thereof is extended from a lateral wall of the ducting pipe (323) to connect a slot (324) of the sealing portion (32). A central shaft (331) is formed inside the buffer spring (33), and an upper end thereof is inserted into a lower end of the ducting pipe (323). A first tapered gasket (312) is disposed on the body portion (31) of the control shaft (30) while a second tapered gasket (31) is disposed on the sealing portion (32) thereof, and two tip portions of the first tapered gasket and the second tapered gasket are facing in opposite direction.

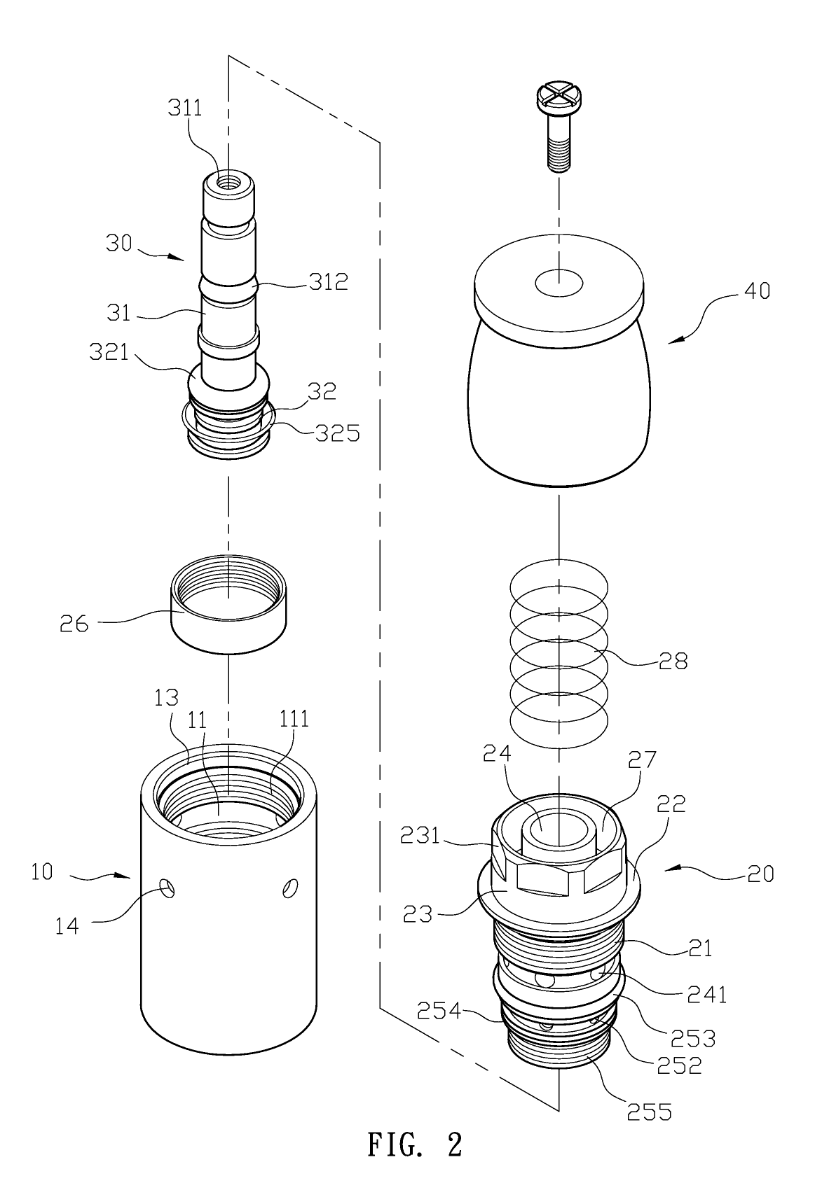

Referring to FIGS. 2 to 4, the control shaft (30) is inserted into the valve base (20), resulting in the connecting end (311) of the control shaft (30) sticking out of the slot (24) and the body portion (31) secured inside thereof. The sealing portion (32) is secured inside the chamber (25), and the O-ring (321) is pressed against the blocking piece (251) to seal the chamber (25). The second tapered gasket (321) is pressed against an inner wall of the chamber (25) to achieve buffering effect, and the recessed portion (322) is formed at the lower portion of the sealing portion (32) to receive the buffer spring (33). The central shaft (331) is formed inside the buffer spring (33), and an upper end thereof is inserted into the lower end of the ducting pipe (323). The bottom nut (26) screws into outer threaded segment (255) of the chamber (25) to secure the buffer spring (33) beneath the control shaft (30). After that, the assembling process between the valve base (20) and the control shaft (30) is completed. The valve base (20) with the control shaft (30) is secured inside the compartment (11) of the valve body (10), and the second threaded segment (21) is screwed into the first threaded segment (111) of the valve body (10) till the flange (22) of the valve base (20) is pressed against a peripheral edge of the opening (14). The outlet holes (241) of the valve base (20) are deposited at the positions corresponding to each of the water outlets (14) of the valve body (10), and the watertight gasket (211) and the leakproof gasket (253) are configured to achieve the sealing effect between the valve base (20) and valve body (10). The annual groove (27) is formed at the upper surface of the protruding portion (23) to receive the coil spring (28). The connecting end (311) formed at an upper end of the control shaft (30) sticks out of the valve base (20) in order to connect the top cap (40). An upper end of the coil spring (28) is pressed against the top cap (40) while a lower end thereof is disposed on the annual groove (27) of the valve base (20), and a space is formed between the top cap (40) and the valve base (20) for the expansion of the coil spring (28).

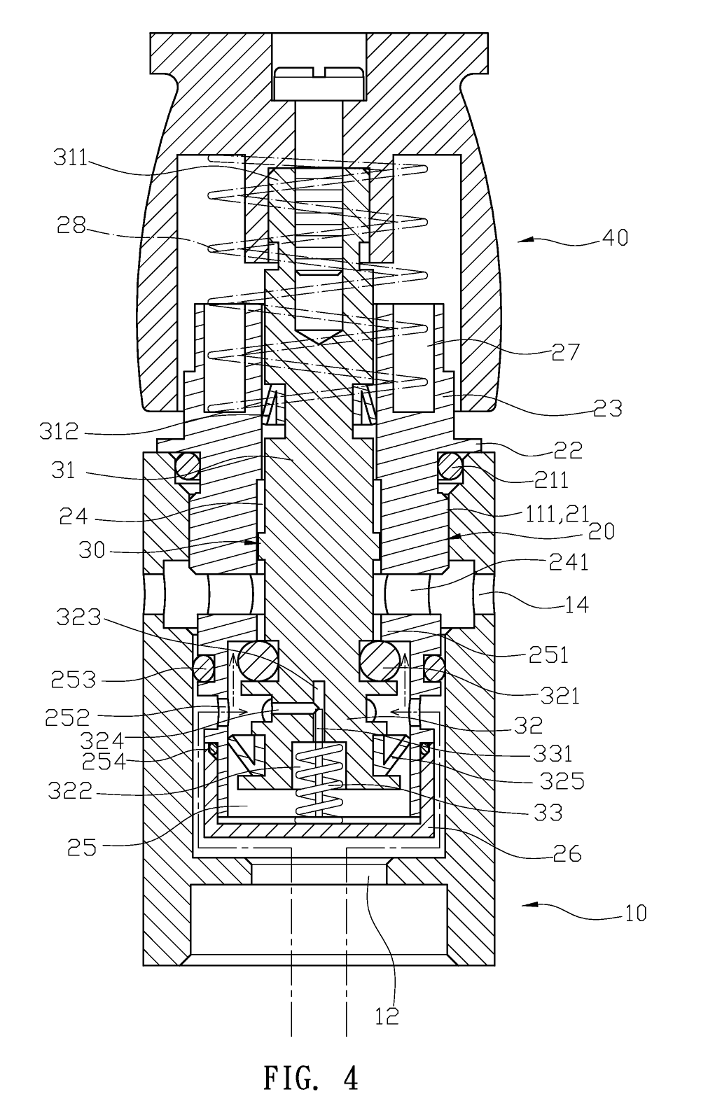

In actual application, referring to FIG. 4, when the self-shut valve of present invention is closed, the control shaft (30) is upward pressed against the top cap (40) due to the elastic force of coil spring (28), resulting in the sealing portion (32) moving up and the O-ring (321) thereon pressing against the blocking piece (251). The buffer spring (33) pressed against the bottom of the control shaft (30) provides an upward force to close the chamber (25). As a result, the water flows into chamber (25) from the water inlet (12) and the inlet holes (252) are blocked and the faucet is closed.

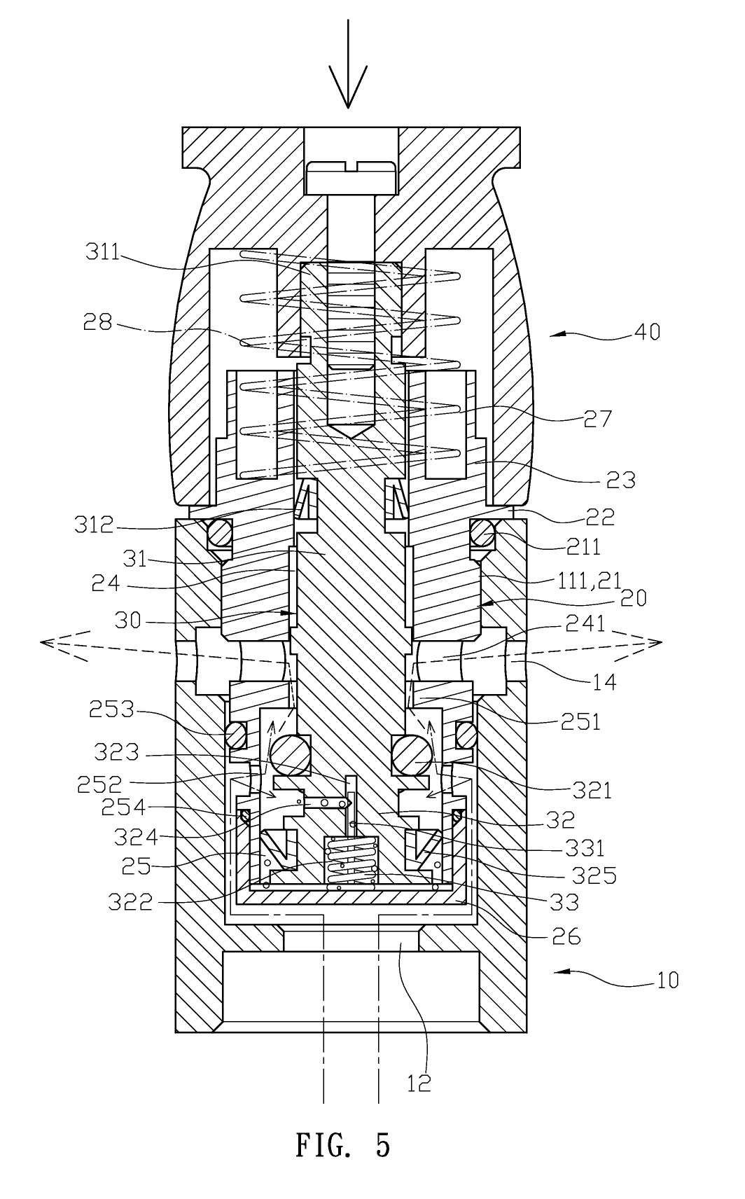

Referring to FIG. 5, the faucet valve is opened when the top cap (40) is pushed downward by a user. Simultaneously, the coil spring (28), the control shaft (30) and the buffer spring (33) are pressed downward , resulting in the sealing portion (32) detaching from the blocking piece (251) of the chamber (25), and the water in the chamber (25) can flow through the slot (24) out of outlet holes (241) and water outlets (14). After the user removes the hand, the top cap is pushed upward by the control shaft (30) and gradually back to its initial position automatically due to the elastic force of the coil spring (28) and the buffer spring (33). The first tapered gasket (312) disposed on the body portion (31) of the control shaft (30) is pressed against an inner wall of the slot (24) while the second tapered gasket (325) disposed on the sealing portion (32) thereof is pressed against the inner wall of chamber (25), and the frictional force between the control shaft (30) and the valve base (20) can make the control shaft (30) to return its initial position slower. Also, the slot (324) of the sealing portion (32) and the ducting pipe (323) are configured to prevent the control shaft (30) from entering a vacuum state. In the present invention, the control shaft (30) can be pushed upward slowly and precisely till the O-ring (321) disposed on the sealing portion (32) is pressed against the blocking piece (251) of the chamber (25), resulting in the faucet being closed.

Also, when the control shaft (30) is pushed up and down by the expansion of the coil spring (28), the central shaft (331) formed inside the buffer spring (33) is moved corresponding to the control shaft (30) inside the ducting pipe (323). The movement of the central shaft (331) can achieve the clean effect of the ducting pipe (323), and enforce the air conduction inside the faucet valve. As a result, the control shaft (30) pressed by the coil spring (28) can be returned to its initial position precisely.

Comparing with conventional self-shut faucets, the present invention is advantageous because (i) the sealing portion (32) of the control shaft (30) comprises the ducting pipe (323) and the slot (324) which can prevent the space between the valve base (20) and the control shaft (30) from entering a vacuum state. Thus, the control shaft (30) can return its initial position precisely; and (ii) the central shaft (331) formed inside the buffer spring (33) is moved corresponding to the control shaft (30) inside the ducting pipe (323). The movement of the central shaft (331) can achieve the clean effect of the ducting pipe (323), and enforce the air conduction inside the faucet valve. As a result, the control shaft (30) pressed by the coil spring (28) can be returned to its initial position precisely.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A self-shut valve for a faucet comprising:
a hollow valve body having a compartment formed inside; a water inlet formed at a bottom portion of the compartment; an opening formed at a top portion thereof to connect with the valve base, and a plurality of water outlets formed at a lateral wall of the compartment between the water inlet and the opening;
a valve base comprising a slot axially penetrating through a central portion thereof in order to receive the control shaft, and a chamber formed inside the valve base connected to a lower end of the slot, and a plurality of outlet holes formed at a lower periphery of the slot, a chamber comprising a blocking piece having a diameter larger than the slot, and a plurality of inlet holes formed on a lateral wall of the chamber; a bottom nut covering an outer wall of the chamber, and an annual groove formed at an upper portion of the valve base to receive a coil spring;
a control shaft comprising a body portion and a sealing portion, and a diameter of the sealing portion larger than the body portion, the body portion secured inside the slot of the valve base, and a connecting end formed at an upper end of the control shaft sticking out of the slot in order to connect with the top cap; the sealing portion secured inside the chamber, and an O-ring disposed thereon to prevent water leak; a recessed portion formed at a lower portion of the sealing portion in order to receive a buffer spring, a T-shaped ducting pipe extended from a top of the recessed portion, and a branch thereof extended from a lateral wall of ducting pipe to connect a slot of the sealing portion, a central shaft formed inside the buffer spring, and an upper end thereof inserted into a lower end of the ducting pipe.

2. The self-shut valve for a faucet of claim 1, wherein the valve body comprises a first threaded segment to screw into a second threaded segment of the valve base, resulting in the valve body securing on the valve base.

3. The self-shut valve for a faucet of claim 2, wherein a flange formed on a top of the second threaded segment of the valve base is pressed against a peripheral edge of the opening, and a watertight gasket is disposed between the flange and the second threaded segment, and a protruding portion is formed at a top portion of the flange, and an engaging portion is formed at a top periphery thereof to lose its circular shape.

4. The self-shut valve for a faucet of claim 1, wherein a sealing gasket disposed on an outer wall of the chamber is located below inlet holes, and an outer threaded segment is formed at a lower end of the sealing gasket to be screwed by the bottom nut.

5. The self-shut valve for a faucet of claim 1, wherein a leakproof gasket disposed on the outer wall of the chamber is located beyond the inlet holes, and is pressed against an inner wall of the valve body to achieve the sealing effect.

6. The self-shut valve for a faucet of claim 1, wherein a first tapered gasket is disposed on the body portion of the control shaft while a second tapered gasket is disposed on the sealing portion thereof, and two tip portions of the first tapered gasket and the second tapered gasket are facing in opposite direction.
